(19) United States
(12) Patent Application Publication
(10) Pub. No.: US 2010/0134929 A1
(43) Pub. Date: Jun. 3, 2010

(54) Multi-Channel Thin-Film Magnetic Head And Magnetic Tape Drive Apparatus With The Multi-Channel Thin-Film Magnetic Head

(75) Inventor: Yuji Ito, Tokyo (JP)

Correspondence Address: Frommer Lawrence & Haug LLP, 745 Fifth Avenue, New York, NY, 10051, US

(73) Assignee: TDK Corporation, Tokyo (JP)

(21) Appl. No.: 12/327,474

(22) Filed: Dec. 3, 2008

(51) Int. Cl. G11B 5/33; G11B 5/127

(52) U.S. Cl. 360/313; 360/110; G9B/5.104; G9B/5.04

(57) ABSTRACT

A multi-channel thin-film magnetic head includes a head section provided with a plurality of thin-film magnetic head elements and a sliding surface for a magnetic tape, a slot section running in a direction perpendicular to a magnetic tape transport direction, the slot section being arranged adjacent to the head section in the magnetic tape transport direction, and an outrigger section provided with a sliding surface for the magnetic tape and arranged to separate from the head section by the slot section in the magnetic tape transport direction. The sliding surface of the outrigger section includes a sloped surface with a height that reduces as approaching the head section.

### BACKGROUND OF THE INVENTION

1. Field of the Invention

The present invention relates to a multi-channel thin-film magnetic head, and to a multi-channel magnetic tape drive apparatus with the multi-channel thin-film magnetic head.

2. Description of the Related Art

In the multi-channel magnetic tape drive apparatus, a multi-channel thin-film magnetic head with read head elements and write head elements for a large number of channels is provided. For example, in the multi-channel magnetic tape drive apparatus (the fourth generation) with the LTO (linear tape open) technical standard, a multi-channel thin-film magnetic head provided with read head elements of 16 channels, write head elements of 16 channels and servo magnetic head elements of 2 channels is used.

Recently, with enhancement in the performance of the multi-channel magnetic tape drive apparatus, required is adoption of a high performance write head element and a high performance read head element that are data transducers in each channel of the multi-channel thin film magnetic head. Also, required is a head structure for closely contacting a moving magnetic tape to a tape sliding surface of each data transducer, in other words for keeping a magnetic spacing between the magnetic tape and the sliding surface of the magnetic head as small as possible.

In a multi-channel tape drive apparatus, in typical, a magnetic tape bi-directionally moves for performing read and write operations. Thus, in most cases, two multi-channel thin film magnetic heads are arranged along a running path of the magnetic tape and each head is switched depending upon the moving direction of the tape.

In case of a flat type head with a flat sliding surface, a negative pressure will occur due to masking of air at a tape-approaching side edge of the sliding surface and due to discharging of air at a tape-leaving side edge of the sliding surface. By this negative pressure, the magnetic tape will make in contact with the sliding surface of the head. In this case, it is necessary to adjust with high precision a protruding amount of the head in a direction toward the magnetic tape, an angle of the sliding surface with respect to the magnetic tape surface (hereinafter called as inclination angle or taper angle), and an installation angle of the head.

However, for all the multi-channel thin film magnetic heads, it is extremely difficult to adjust their protruding amounts of the heads, the inclination angles and the installation angles of the heads to ideal values in this way. For example, when the protruding amount of the head in the direction toward the magnetic tape is small, when the inclination angle of the sliding surface of the head is too large or when the installation angle of the head inclines, at the tape-approaching side edge of the sliding surface, the magnetic tape does not touch the edge and thus the masking effect of air is lost, whereas at the tape-leaving side edge of the sliding surface, because an angle between the tape and the sliding surface becomes too large causing the discharge of air at this edge to be suppressed. If the discharge of air is limited at the tape-leaving side edge, the air is easy to pool between the tape and the sliding surface causing the magnetic spacing to increase.

U.S. Pat. No. 7,271,983 B2 (Saliba) discloses a magnetic head with outriggers arranged along the tape transport direction in a data island associated with a data transducer so as to reduce a head-tape separation or a magnetic spacing between the data transducer of the head and the magnetic tape.

However, even in case that the outriggers taught in Saliba is provided, if the inclination angle of the sliding surface becomes large, the magnetic tape never touches the edge at the tape-approaching side and thus the masking effect of air is lost causing the magnetic spacing to increase.

### SUMMARY OF THE INVENTION

It is therefore an object of the present invention to provide a multi-channel thin-film magnetic head and a multi-channel magnetic tape drive apparatus, whereby a magnetic spacing can be minimized irrespective of a protruding amount of the head, an inclination angle of a sliding surface of the head and an installation angle of the head.

According to the present invention, a multi-channel thin-film magnetic head includes a head section provided with a plurality of thin-film magnetic head elements and a sliding surface for a magnetic tape, a slot section running in a direction perpendicular to a magnetic tape transport direction, the slot section being arranged adjacent to the head section in the magnetic tape transport direction, and an outrigger section provided with a sliding surface for the magnetic tape and arranged to separate from the head section by the slot section in the magnetic tape transport direction. The sliding surface of the outrigger section includes a sloped surface with a height that reduces as approaching the head section.

The outrigger section is provided outside of the head section to separate from the head-section sliding surface by a slot section, and the sliding surface of the outrigger section is inclined toward the head section so that a height of the outrigger section reduces as approaching the head section. Therefore, the sliding surface of the outrigger section has a minus inclination angle with respect to that of the sliding surface of the head section. Thus, a negative pressure occurs at this sliding surface of the outrigger section to allow the magnetic tape closely contact with this sliding surface. As a result, because the magnetic tape is guided to a position that is lower than the sliding surface of the head section, this magnetic tape comes into contact with an edge of the sliding surface of the head section. Thus, negative pressure occurs due to masking effect at the edge of the sliding surface of the head section, and therefore the magnetic tape comes into closely contact with the sliding surface of the head section. Accordingly, the magnetic spacing can be controlled at the minimum without depending on a protruding amount of the head section, an inclination angle of the sliding surface of the head section and an installation angle of the head section.

It is preferred that the multi-channel thin-film magnetic head further includes a closure fixed on the plurality of thin-film magnetic head elements of the head section.

It is also preferred that the sloped surface includes an inclined surface formed in an area of the sliding surface of the outrigger section near the head section, or formed over substantially whole area of the sliding surface of the outrigger section.

It is further preferred that the sliding surface of the head section is arranged at a position nearer to the magnetic tape than a head-section side edge of the sliding surface of the outrigger section.

It is further preferred that a head-section side edge of the sliding surface of the outrigger section is arranged at a position nearer to the magnetic tape than the sliding surface of the head section. In this case, more preferably, a height h′ is equal to or lower than a product of d×tan θ(h′≦d×tan θ), where θ is an inclination angle of the sloped surface with respect to the sliding surface of the head section, h′ is a height of the sliding surface of the head section with respect to the head-section side edge and d is a width of the slot section in the magnetic tape transport direction.

It is still further preferred that a width d of the slot section in the magnetic tape transport direction is larger than 0.1 mm and smaller than 2.0 mm (0.1 mm≦d≦2.0 mm).

It is further preferred that the plurality of thin-film magnetic head elements include a plurality of magnetoresistive effect (MR) read head elements and a plurality of inductive write head elements. In this case, more preferably, each of the plurality of MR read head elements comprises a giant magnetoresistive effect (GMR) read head element or a tunnel magnetoresistive effect (TMR) read head element.

According to the present invention, also, a multi-channel magnetic tape drive apparatus includes a pair of multi-channel thin-film magnetic heads, a magnetic tape facing to the pair of multi-channel thin-film magnetic heads, and a drive system for relatively moving the magnetic tape and the pair of multi-channel thin-film magnetic heads. Each of the pair of multi-channel thin-film magnetic heads includes a head section provided with a plurality of thin-film magnetic head elements and a sliding surface for a magnetic tape, a slot section running in a direction perpendicular to a magnetic tape transport direction, the slot section being arranged adjacent to the head section in the magnetic tape transport direction, and an outrigger section provided with a sliding surface for the magnetic tape and arranged to separate from the head section by the slot section in the magnetic tape transport direction. The sliding surface of the outrigger section includes a sloped surface with a height that reduces as approaching the head section.

The outrigger section is provided outside of the head section to separate from the head-section sliding surface by a slot section, and the sliding surface of the outrigger section is inclined toward the head section so that a height of the outrigger section reduces as approaching the head section. Therefore, the sliding surface of the outrigger section has a minus inclination angle with respect to that of the sliding surface of the head section. Thus, a negative pressure occurs at this sliding surface of the outrigger section to allow the magnetic tape closely contact with this sliding surface. As a result, because the magnetic tape is guided to a position that is lower than the sliding surface of the head section, this magnetic tape comes into contact with an edge of the sliding surface of the head section. Thus, negative pressure occurs due to masking effect at the edge of the sliding surface of the head section, and therefore the magnetic tape comes into closely contact with the sliding surface of the head section. Accordingly, the magnetic spacing can be controlled at the minimum without depending on a protruding amount of the head section, an inclination angle of the sliding surface of the head section and an installation angle of the head section.

It is preferred that each multi-channel thin-film magnetic head further includes a closure fixed on the plurality of thin-film magnetic head elements of the head section.

It is also preferred that, in each multi-channel thin-film magnetic head, the sloped surface includes an inclined surface formed in an area of the sliding surface of the outrigger section near the head section, or formed over substantially whole area of the sliding surface of the outrigger section.

It is further preferred that, in each multi-channel thin-film magnetic head, the sliding surface of the head section is arranged at a position nearer to the magnetic tape than a head-section side edge of the sliding surface of the outrigger section.

It is further preferred that, in each multi-channel thin-film magnetic head, a head-section side edge of the sliding surface of the outrigger section is arranged at a position nearer to the magnetic tape than the sliding surface of the head section. In this case, more preferably, a height h′ is equal to or lower than a product of d×tan θ(h′≦d×tan θ), where θ is an inclination angle of the sloped surface with respect to the sliding surface of the head section, h′ is a height of the sliding surface of the head section with respect to the head-section side edge and d is a width of the slot section in the magnetic tape transport direction.

It is still further preferred that, in each multi-channel thin-film magnetic head, a width d of the slot section in the magnetic tape transport direction is larger than 0.1 mm and smaller than 2.0 mm (0.1 mm≦d≦2.0 mm).

It is further preferred that, in each multi-channel thin-film magnetic head, the plurality of thin-film magnetic head elements include a plurality of MR read head elements and a plurality of inductive write head elements. In this case, more preferably, each of the plurality of MR read head elements comprises a GMR read head element or a TMR read head element.

Further objects and advantages of the present invention will be apparent from the following description of the preferred embodiments of the invention as illustrated in the accompanying drawings.

### BRIEF DESCRIPTION OF THE DRAWINGS

FIG. 1 is a perspective view schematically illustrating constitution of a multi-channel magnetic tape drive apparatus as a one embodiment according to the present invention;

FIG. 2 is an enlarged perspective view illustrating constitution of the multi-channel thin-film magnetic head shown in FIG. 1 and its peripheral portion;

FIG. 3 is a perspective view schematically illustrating relative constitution between the multi-channel thin film magnetic head shown in FIG. 1 and a multi-channel magnetic tape;

FIG. 4 is a sectional view along a plane section A shown in FIG. 3, illustrating internal configuration of the multi-channel thin film magnetic head shown in FIG. 1;

FIG. 5 is a sectional view along a plane section B shown in FIG. 3, illustrating the internal configuration of the multi-channel thin film magnetic head shown in FIG. 1;

FIG. 6 is a view illustrating functions of the multi-channel thin film magnetic head shown in FIG. 1;

FIGS. 7a to 7e are views schematically illustrating in comparison functions of the multi-channel thin film magnetic head according to the conventional art and the multi-channel thin film magnetic head according to the present invention;

FIGS. 8a and 8b are views concretely illustrating relationships in height between a sliding surface in an outrigger section and a sliding surface in a head section in the multi-channel thin film magnetic head according to the present invention; and

FIG. 9 is a view concretely illustrating a relationship in angle between the sliding surface in the outrigger section and the sliding surface in the head section in the multi-channel thin film magnetic head according to the present invention.

### DESCRIPTION OF THE PREFERRED EMBODIMENTS

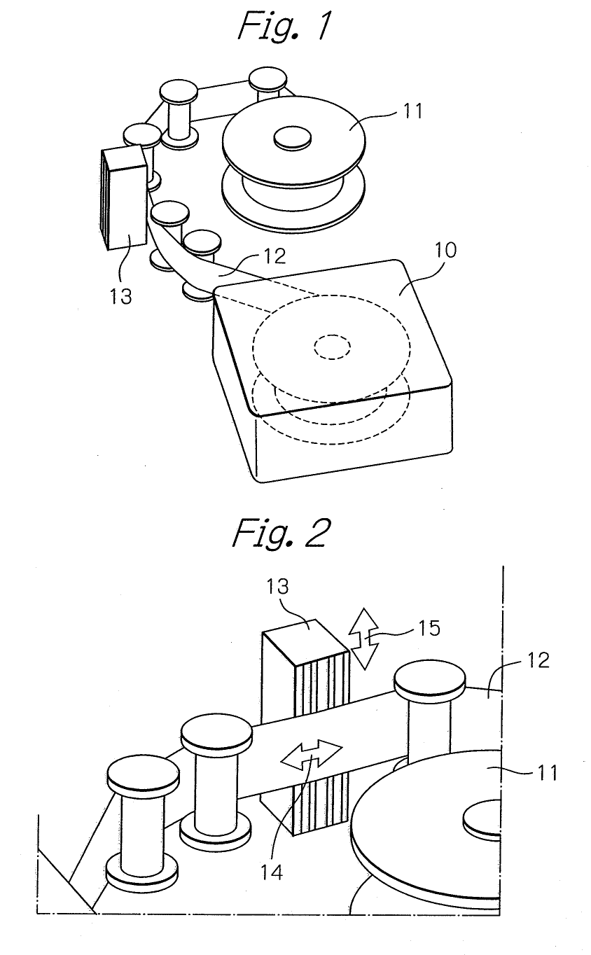

FIG. 1 schematically illustrates constitution of a multi-channel magnetic tape drive apparatus as a one embodiment according to the present invention, and FIG. 2 illustrates constitution of the multi-channel thin-film magnetic head shown in FIG. 1 and its peripheral portion.

In this embodiment, applied is the present invention to a LTO multi-channel magnetic tape drive apparatus of the fourth generation. Of course, the present invention is not limited to the multi-channel magnetic tape drive apparatus of LTO but is applicable to any kind of multi-channel magnetic tape drive apparatus.

In FIGS. 1 and 2, a reference numeral 10 denotes a tape cartridge with a single reel, 11 denotes a take-up reel for temporarily rewinding a multi-channel magnetic tape 12 drawn out from the tape cartridge 10, and 13 denotes a multi-channel thin-film magnetic head, respectively. The multi-channel thin-film magnetic head 13 can reciprocate in directions or track-width directions 15 perpendicular to reciprocating running directions 14 of the multi-channel magnetic tape 12.

As is known in the art, in LTO, write and read operations are performed to and from the multi-channel magnetic tape 12 of the half-inch width. The multi-channel thin film magnetic head 13 for this purpose is provided with magnetic read head elements of 16 channels, magnetic write head elements of 16 channels and magnetic servo head elements of 2 channels.

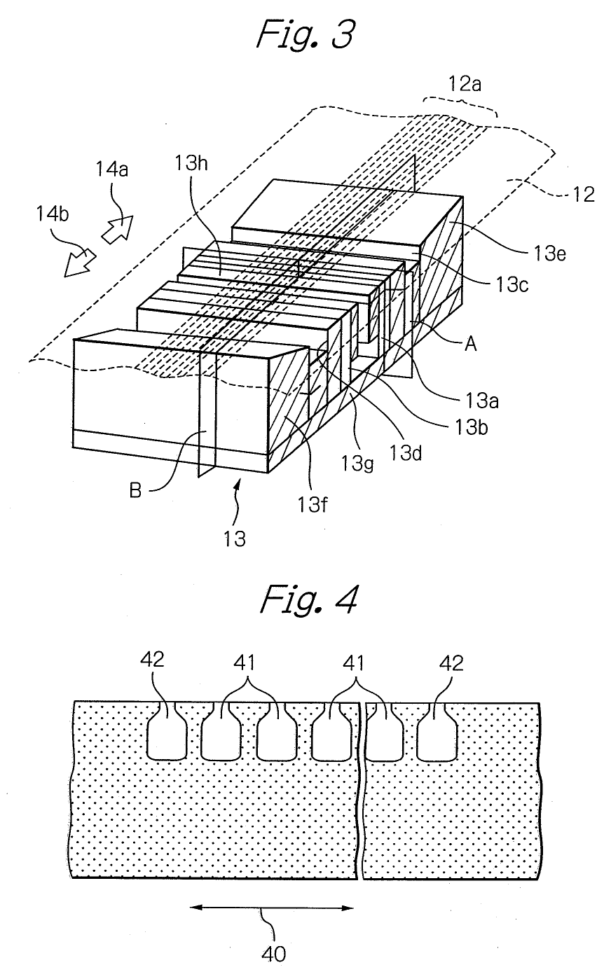

FIG. 3 schematically illustrates relative constitution between the multi-channel thin film magnetic head shown in FIG. 1 and a multi-channel magnetic tape 12.

As shown in the figure, the multi-channel magnetic tape 12 has a plurality of tracks 12a. Also, the multi-channel thin-film magnetic head 13 has a first head section 13a, a second head section 13b, a first slot section 13c, a second slot section 13d, a first outrigger section 13e, a second outrigger section 13f and a frame 13g for supporting the both head sections and the both outrigger sections.

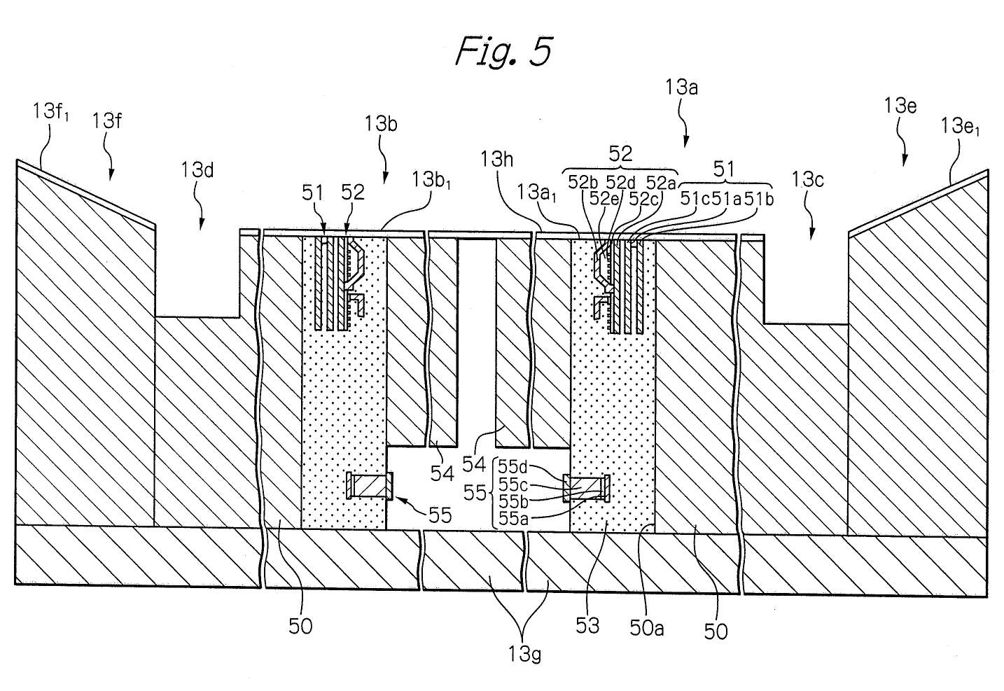

When performing write and read operations, the magnetic tape 12 moves in direction of arrow 14a or arrow 14b. The write and read operations of data signal with respect to the tracks 12a of the magnetic tape 12 are performed under the state where a tape bearing surface (TBS) 13h of the thin-film magnetic head 13 is in contact with the surface of the moving magnetic tape 12. The first head section 13a has a head-section sliding surface 13a₁ (shown in FIG. 5) that constitutes a part of the TBS 13h, and the second head section 13b has a head-section sliding surface 13b₁ (shown in FIG. 5) that constitutes another part of the TBS 13h. When the magnetic tape 12 moves toward the direction of arrow 14a, for example, read operation is performed in trailing side first head section 13a and write operation is performed in leading side second head section 13b. Whereas when the magnetic tape 12 moves to the opposite direction of arrow 14b, read and written head sections are replaced. In modifications of the present invention, only one of the first and second head sections 13a and 13b may be provided in the thin-film magnetic head 13.

The first slot section 13c is arranged adjacent to the first head section 13a in the tape transport direction 14a. This first slot section 13c runs along a direction perpendicular to the tape transport direction 14a. The first outrigger section 13e is separated from the first head section 13a in the tape transport direction 14a by the first slot section 13c. This first outrigger section 13e has an outrigger-section sliding surface 13e₁ (shown in FIG. 5) that constitutes a part of the TBS 13h and slides the magnetic tape 12. Similar to this, the second slot section 13d is arranged adjacent to the second head section 13b in the tape transport direction 14b. This second slot section 13d runs along a direction perpendicular to the tape transport direction 14b. The second outrigger section 13f is separated from the second head section 13b in the tape transport direction 14b by the second slot section 13d. This second outrigger section 13f has an outrigger-section sliding surface 13f₁ (shown in FIG. 5) that constitutes a part of the TBS 13h and slides the magnetic tape 12.

FIGS. 4 and 5 illustrate internal configuration of the multi-channel thin film magnetic head shown in FIG. 1. In particular, FIG. 4 shows a section along a plane section A of FIG. 3 and FIG. 5 shows a section along a plane section B of FIG. 3. Because the first head section 13a, the first slot section 13c and the first outrigger section 13e of the thin-film magnetic head 13 are opposed to the second head section 13b, the second slot section 13d and the second outrigger section 13f of the thin-film magnetic head 13 in the direction along the tracks and they have the similar constitution to each other, hereinafter explanation will be performed for the first head section 13a, the first slot section 13c and the first outrigger section 13e only.

As partially shown in FIG. 4, the thin-film magnetic head 13 has magnetic head elements 41 consisting of magnetic read head elements and magnetic write head elements of 16 channels and magnetic servo head elements 42 of 2 channels, aligned along the track-width direction 40 that is perpendicular to the transport direction of the magnetic tape 12, formed on an element forming surface 50a of a head substrate 50, which is perpendicular to the TBS 13h.

As shown in FIG. 5, the first section 13a of the thin-film magnetic head 13 has the head substrate 50 made of for example AlTiC (Al₂O₃—TiC), GMR read head elements 51 formed on the element forming surface 50a for reading out data signal, inductive write head elements 52 formed just on the GMR read head elements 51 for writing the data signal, a protection layer 53 formed on the element forming surface 50a to cover these GMR read head elements 51 and inductive write head elements 52, a closure 54 made of for example AlTiC (Al₂O₃—TiC) and adhered to the protection layer 53, and a plurality of terminal electrodes 55 formed on an exposed area of an upper surface of the protection layer 53, to which area no closure 54 is adhered.

It should be noted that, in the section shown in FIG. 5, only one magnetic head element consisting of the GMR read head element 51 and the inductive write head element 52 is revealed for each of the first and second head sections 13a and 13b.

The plurality of GMR read head elements 51 are electrically connected to the plurality of terminal electrodes 55, respectively. Also, one ends of each GMR read head element 51 and each inductive write head element 52 are arranged to reach the TBS 13h and to come in contact with the relatively moving magnetic tape 12. Therefore, during writing operation, the inductive write head elements 52 apply signal magnetic fields to the respective tracks of the moving magnetic tape 12 to write data thereto, and during read operation, the GMR read head elements 51 receive signal magnetic fields from the respective tracks of the moving magnetic tape 12 to read data there from.

Each of the GMR read head elements 51 includes, as shown in FIG. 5, a GMR multi-layered structure 51a, and a pair of a lower shield layer 51b and an upper shield layer 51c arranged to sandwich the GMR multi-layered structure 51a. The lower shield layer 51b and the upper shield layer 51c prevent the GMR multi-layered structure 51a from receiving external magnetic field or noise. Each of these lower shield layer 51b and upper shield layer 51c is formed, by using for example a frame plating method or a sputtering method, from a single layer or multilayer of soft magnetic materials such as FeSiAl (Sendust), NiFe (permalloy), CoFeNi, CoFe, FeN, FeZrN or CoZrTaCr, with a thickness of about 0.5-3.0 μm.

The GMR multi-layered structure 51a constitutes a magnetic sensitivity portion for detecting a signal magnetic field by utilizing the giant magnetoresistive effect. Instead of the GMR multi-layered structure 51a, an anisotropic magnetoresistive effect (AMR) structure utilizing anisotropic magnetoresistive effect or a tunnel magnetoresistive effect (TMR) multi-layered structure utilizing tunneling magnetoresistive effect may be used. In case of the GMR multi-layered structure, either current in plane (CIP) type GMR multi-layered structure or current perpendicular to plane (CPP) type GMR multi-layered structure may be adopted. The GMR multi-layered structure 51a will receive a signal magnetic field from each track 12a of the magnetic tape 12 with high sensitivity. In case that the GMR multi-layered structure 51a is the CPP-GMR multi-layered structure or that a TMR multi-layered structure is used instead of the GMR multi-layered structure, the lower shield layer 51b and the upper shield layer 51c serve as electrodes. On the other hand, in case that the GMR multi-layered structure 51a is the CIP-GMR multi-layered structure or that an AMR structure is used in stead of the GMR multi-layered structure, it is provided with insulation layers between the CIP-GMR multi-layered structure or the AMR structure and the lower and upper shield layers 51b and 51c, respectively and also it is provided with MR lead layers electrically connected to the CIP-GMR multi-layered structure or the AMR structure.

Each of the inductive write head elements 52 includes, as shown in FIG. 5, a lower magnetic pole layer 52a, an upper magnetic pole layer 52b, a write gap layer 52c with an end section near the TBS 13h, sandwiched between the lower magnetic pole layer 52a and the upper magnetic pole layer 52b near the TBS 13h, a write coil layer 52d formed to pass through at each turn between at least the lower magnetic pole layer 52a and the upper magnetic pole layer 52b, and a coil insulating layer 52e for insulating the write coil layer 52d from the lower magnetic pole layer 52a and the upper magnetic pole layer 52b.

The lower magnetic pole layer 52a and the upper magnetic pole layer 52b function as a magnetic path of magnetic flux produced from the write coil layer 52d and also sandwich by their end sections the TBS side end section of the write gap layer 52c. The write operation is performed by means of leakage flux output from the sandwiched end section of the write gap layer 52c. In the figure, it is depicted that the write coil layer 52d has a single layer structure. However, in modifications, the write coil layer may have a multi-layered structure or a helical coil structure. Also, in modifications, a single common magnetic layer may serve as both the upper shield layer 51c of the GMR read head element 51 and the lower magnetic pole layer 52a of the inductive write head element 52 laminated on the GMR read head element 51.

The lower magnetic pole layer 52a is formed, by using for example a frame plating method or a sputtering method, from a single layer or multilayer of soft magnetic materials such as NiFe, CoFeNi, CoFe, FeN, FeZrN or CoZrTaCr, with a thickness of about 0.5-3.0 μm. The write gap layer 52c is formed, by using for example a sputtering method or a chemical vapor deposition (CVD) method, from a nonmagnetic insulating material such as Al₂O₃ (alumina), SiO₂ (silicon dioxide), AlN (aluminum nitride) or DLC, with a thickness of about 0.01-0.05 μm. The write coil layer 52d is formed, by using for example a frame plating method or a sputtering method, from a conductive material such as Cu, with a thickness of about 0.5-5.0 μm. The coil insulation layer 52e is formed, by using for example a photolithography method, from a resin insulation material cured by heating, such as a novolac photoresist, with a thickness of about 0.7-7.0 μm. The upper magnetic pole layer 51c is formed, by using for example a frame plating method or a sputtering method, from a single layer or multilayer of soft magnetic materials such as NiFe, CoFeNi, CoFe, FeN, FeZrN or CoZrTaCr, with a thickness of about 0.5-3.0 μm. Also, the protection layer 53 is formed, by using for example a sputtering method or a CVD method, from a nonmagnetic insulating material such as Al₂O₃, SiO₂, AlN or DLC.

Each of the terminal electrodes 55 includes a drawing electrode 55a, an electrode film 55b, a bump 55c and a pad 55d. The drawing electrodes 55a are electrically connected to lead lines from the GMR read head element 51 and from the inductive write head element 52. On each drawing electrode 55a, the electrode film 55b having conductivity is laminated, and the bump 55c is formed on the electrode film 55b by plating using this film 55b as an electrode for plating. The electrode film 55b and the bump 55c are made of a conductive material such as Cu. A thickness of the electrode film 55b is for example about 10-200 nm, and a thickness of the bump 55c is for example about 5-30 μm. A top end of the bump 55c is exposed from the top surface of the protection layer 53, and the pad 55d is laminated on this top end of the bump 55c.

As shown in FIG. 5, the first slot section 13c opened to the TBS 13h that faces the magnetic tape 12 is formed in the head substrate 50 of the first head section 13a. The first outrigger section 13e made of for example AlTiC is fixed to this head substrate 50 so that the first slot section 13c is adjacent to the first trigger section 13e. Also, the second slot section 13d opened to the TBS 13h that faces the magnetic tape 12 is formed in the head substrate 50 of the second head section 13b. The second outrigger section 13f made of for example AlTiC is fixed to this head substrate 50 so that the second slot section 13d is adjacent to the second trigger section 13f.

The aforementioned outrigger-section sliding surface 13e₁ of the first outrigger section 13e has a sloping surface inclined toward the first head section 13a. More concretely, in this embodiment, the whole area of the outrigger-section sliding surface 13e₁ of the first outrigger section 13e is configured by an inclined top surface with a height decreasing as approaching the first head section 13a. Whereas the head-section sliding surface 13a₁ of the first head section 13a is a flat surface without being inclined. Similar to this, the aforementioned outrigger-section sliding surface 13f₁ of the second outrigger section 13f has a sloping surface inclined toward the second head section 13b. More concretely, in this embodiment, the whole area of the outrigger-section sliding surface 13f₁ of the second outrigger section 13f is configured by an inclined top surface with a height decreasing as approaching the second head section 13b. Whereas the head-section sliding surface 13b₁ of the second head section 13b is a flat surface without being inclined.

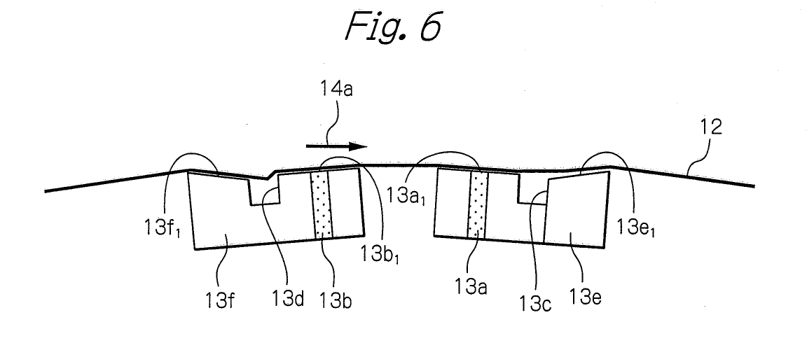

FIG. 6 illustrates functions of the multi-channel thin film magnetic head 13 shown in FIG. 1. As shown in the figure, when the magnetic tape 12 moves in the direction of the arrow 14a, in the second head section 13b, since the outrigger-section sliding surface 13f₁ of the second outrigger region 13f inclines toward the head-section sliding surface 13b₁, negative pressure will occur by this second outrigger section 13f. Thus, it is possible to make closely contact the magnetic tape 12 with the outrigger-section sliding surface 13f₁. As a result, because the magnetic tape 12 is guided to a position that is lower than the head-section sliding surface 13b₁ in the second slot section 13d, this magnetic tape 12 comes into contact with an edge of the head-section sliding surface 13b₁. Thus, negative pressure occurs due to masking effect at the edge of the head-section sliding surface 13b₁, and therefore the magnetic tape 12 comes into closely contact with the head-section sliding surface 13b₁. On the other hand, in the first head section 13a, since negative pressure occurs by inclination itself of the head-section sliding surface 13a₁, the magnetic tape 12 comes into closely contact with the head-section sliding surface 13a₁. Thus, according to this embodiment, the magnetic spacing can be controlled at the minimum without depending on a protruding amount of the head section, an inclination angle of the head-section sliding surface and an installation angle of the head section. As a result, it is possible to obtain excellent head performance with a high-level but small-fluctuation output characteristics.

In case that the magnetic tape 12 moves toward the opposite direction, the first head section 13a and the second head section 13b perform a reversed operations each other.

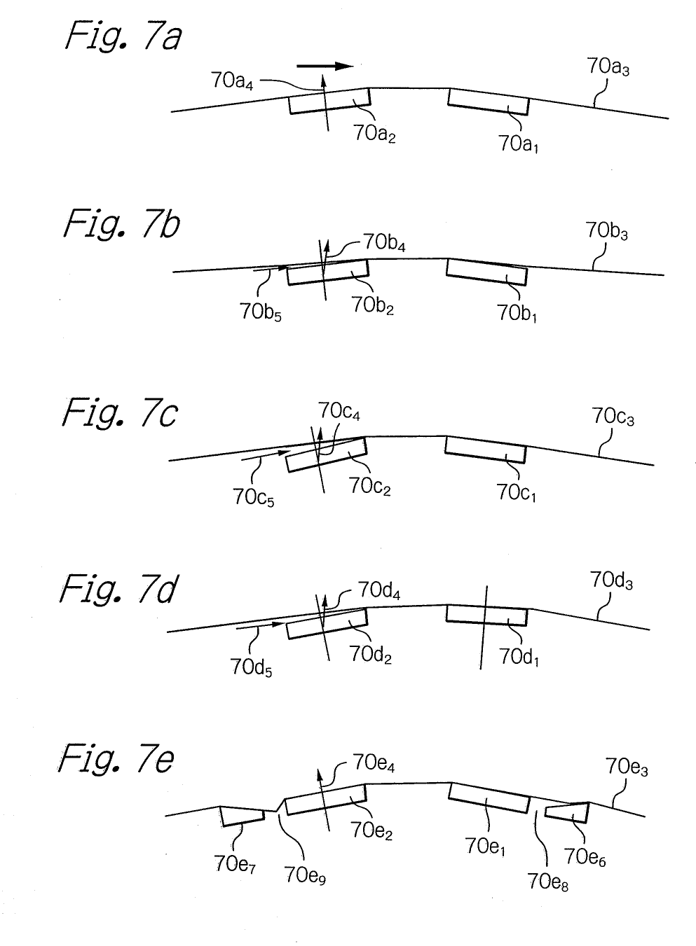

FIGS. 7a to 7e schematically illustrate in comparison functions of the multi-channel thin film magnetic head according to the conventional art and the multi-channel thin film magnetic head according to the present invention.

FIG. 7a shows an example in the prior art, wherein inclination angles or taper angles of sliding surfaces of head sections 70a₁ and 70a₂ and protruding amounts of the head sections 70a₁ and 70a₂ are adjusted ideal. If these parameters are adjusted ideally as in this example, a pressure balance force 70a₄ in a direction perpendicular to the sliding surface will be obtained resulting the magnetic spacing between head section 70a₂ and the magnetic tape 70a₃ becomes quite small. However, such ideal adjustment is extremely difficult.

FIG. 7b shows another example in the prior art, wherein protruding amounts of head sections 70b₁ and 70b₂ are smaller than the ideal values. In such case, inflow of air 70b₅ occurs and thus pressure balance force 70b₄ will lean from the direction perpendicular to the sliding surface. As a result, a magnetic spacing between a head section 70b₂ and a magnetic tape 70b₃ increases.

FIG. 7c shows further example in the prior art, wherein inclination angles of sliding surfaces of head sections 70c₁ and 70c₂ are larger than the ideal values. In such case, inflow of air 70c₅ occurs and thus pressure balance force 70c₄ will lean from the direction perpendicular to the sliding surface. As a result, a magnetic spacing between a head section 70c₂ and a magnetic tape 70c₃ increases.

FIG. 7d shows still further example in the prior art, wherein installation angles of head sections 70d₁ and 70d₂ deviate from ideal values. In such case, inflow of air 70d₅ occurs and thus pressure balance force 70d₄ will lean from the direction perpendicular to the sliding surface. As a result, a magnetic spacing between a head section 70d₂ and a magnetic tape 70d₃ increases.

FIG. 7e shows an example in the present invention, wherein outrigger sections 70e₆ and 70e₇ and slot sections 70e₈ and 70e₉ are provided. Because such outrigger sections 70e₆ and 70e₇ each having a sliding surface inclined toward a head section 70e₁ or 70e₂ are arranged outside the head sections 70e₁ and 70e₂ and also the slot sections 70e₈ and 70e₉ are arranged between the outrigger sections 70e₆ and 70e₇ and the head sections 70e₁ and 70e₂, a magnetic tape 70e₃ is guided to a position that is lower than the sliding surface of the head section 70e₂. Thus, even if protruding amounts of the head sections 70e₁ and 70e₂, inclination angles of the sliding surfaces of head sections 70e₁ and 70e₂, and installation angles of head sections 70e₁ and 70e₂ are not ideally adjusted, a pressure balance force 70e₄ directs to a direction perpendicular to the sliding surface of the head section 70e₂. As a result, a magnetic spacing between the head section 70e₂ and the magnetic tape 70e₃ can be kept at the minimum and therefore it is possible to come into closely contact the bi-directionally movable magnetic tape 70e₃ with the head-section sliding surface to obtain excellent head performance.

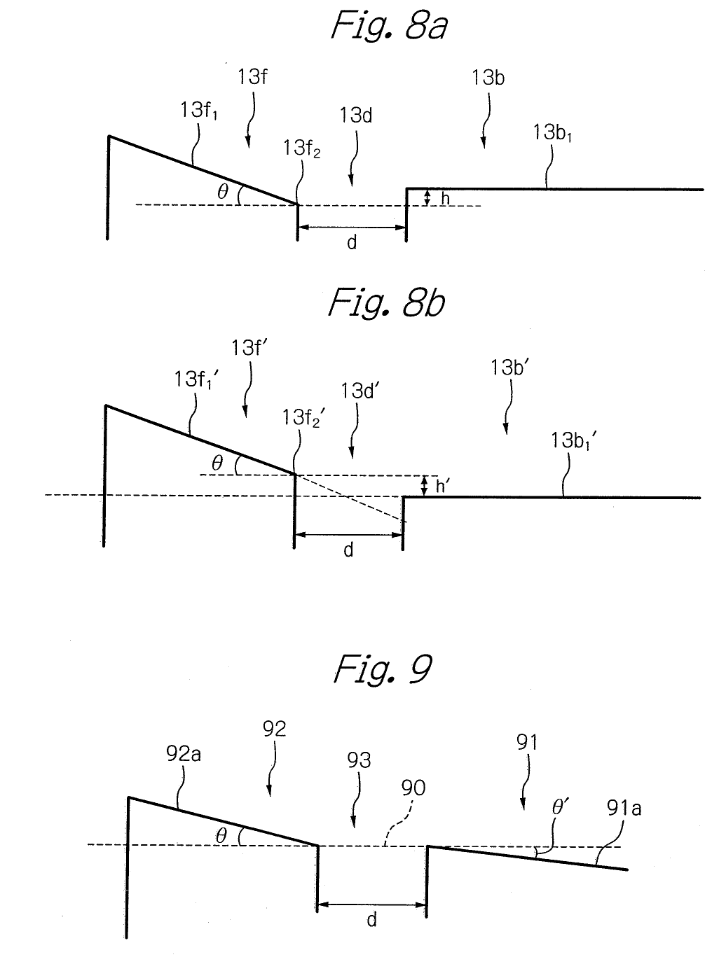

FIGS. 8a and 8b concretely illustrate relationships in height between the sliding surface in the outrigger section and the sliding surface in the head section in the multi-channel thin film magnetic head according to the present invention.

As shown in FIG. 8a, in an embodiment according to the present invention, the head-section sliding surface 13b₁ of the second head section 13b is higher than a head-section side edge 13f₂ of the of the outrigger-section sliding surface 13f₁ of the second outrigger section 13f (that is h>0). In other words, the head-section sliding surface 13b₁ is located nearer to the magnetic tape than the head-section side edge 13f₂. Also, a width d of the second slot section 13d in a direction of magnetic tape transport is set as 0.1 mm≦d≦2.0 mm. The first head section has the similar configuration.

Also, as shown in FIG. 8b, in another embodiment according to the present invention, a head-section side edge 13f₂′ of the of the outrigger-section sliding surface 13f₁′ of the second outrigger section 13f′ is higher than the head-section sliding surface 13b₁′ of the second head section 13b′ (that is h′>0). In other words, the head-section side edge 13f₂′ is located nearer to the magnetic tape than the head-section sliding surface 13b₁′. Also, a width d of the second slot section 13d′ in a direction of magnetic tape transport is set as 0.1 mm≦d≦2.0 mm. Further, it is desired that a height h′ is h′d×tan θ, where θ is an inclination angle of the outrigger-section sliding surface 13f₁′ with respect to the head-section sliding surface 13b₁′ that is flat surface with no inclination, and h′ is a height of the head-section sliding surface 13b₁′ with respect to the head-section side edge 13f₂′ of the outrigger-section sliding surface 13f₁′. The first head section has the similar configuration.

Effect of providing the outrigger-section sliding surface sloped with an inclination angle toward the head-section sliding surface, in other words sloped to have a height decreasing as approaching the head section, was actually validated.

As shown in FIG. 9, a multi-channel thin film magnetic head, in which an inclination angle θ of an outrigger-section sliding surface 92a of an outrigger section 92 with respect to a flat reference surface 90 with no inclination is equal to 0 degree (θ=0°, corresponding to the inclination angle of the prior art), an inclination angle θ′ of a head-section sliding surface 91a of a head section 91 with respect to the reference surface 90 is equal to 2 degree (θ′=2°), and a width d of a slot section 93 along the tape transport direction is equal to 0.5 mm (d=0.5 mm) was prepared. Read-out outputs from read head elements of 15 channels in this multi-channel thin film magnetic head were measured, and then a standard deviation σ/average value Ave of the measured outputs was calculated. The obtained result was σ/Ave=0.15. In this measurement, the moving speed of the magnetic tape was 6.0 m/sec, the tensile force of the magnetic tape was 0.7 N, and the write frequency was 21.1 MHz.

Contrary to this, a multi-channel thin film magnetic head, in which an inclination angle θ of the outrigger-section sliding surface 92a is equal to 2 degrees (θ=2°, corresponding to the inclination angle of the present invention), an inclination angle θ′ of the head-section sliding surface 91a is equal to 2 degree (θ′=2°), and a width d of the slot section 93 is equal to 0.5 mm (d=0.5 mm) was prepared. Read-out outputs from read head elements of 15 channels in this multi-channel thin film magnetic head were measured, and then a standard deviation σ/average value Ave of the measured outputs was calculated. In this measurement, the obtained result was σ/Ave=0.08. The moving speed of the magnetic tape was 6.0 m/sec, the tensile force of the magnetic tape was 0.7 N, and the write frequency was 21.1 MHz.

It will be understood from the above validation that, by sloping the outrigger-section sliding surface toward the head section namely toward the opposite direction as the conventional outrigger section, with the inclination angle of 2 degrees, the read-out outputs from the magnetic head increase and fluctuation of the outputs decreases.

As aforementioned, according to this embodiment, the outrigger section is provided outside of the head section to separate from the head-section sliding surface by a slot section, and the outrigger-section sliding surface is inclined toward the head section so that a height of the outrigger section reduces as approaching the head section, that is, so that the outrigger-section sliding surface has a minus inclination angle with respect to that of the head-section sliding surface. Thus, a negative pressure occurs at the outrigger-section sliding surface to allow the magnetic tape closely contact with the outrigger-section sliding surface. As a result, because the magnetic tape is guided to a position that is lower than the head-section sliding surface, this magnetic tape comes into contact with an edge of the head-section sliding surface. Thus, negative pressure occurs due to masking effect at the edge of the head-section sliding surface, and therefore the magnetic tape comes into closely contact with the head-section sliding surface. When the magnetic tape moves reverse direction, since negative pressure occurs by inclination itself of the head-section sliding surface, the magnetic tape comes into closely contact with the head-section sliding surface.

Therefore, according to this embodiment, the magnetic spacing can be controlled at the minimum without depending on a protruding amount of the head section, an inclination angle of the head-section sliding surface and an installation angle of the head section. As a result, it is possible to increase read-out outputs of the magnetic head and to reduce fluctuation of the outputs.

In the aforementioned embodiment, the whole area of the outrigger-section sliding surface is formed as a sloped surface. However, in modifications, only a part near the head section may be formed as a sloped surface.

Many widely different embodiments of the present invention may be constructed without departing from the spirit and scope of the present invention. It should be understood that the present invention is not limited to the specific embodiments described in the specification, except as defined in the appended claims.

1. A multi-channel thin-film magnetic head comprising:
a head section provided with a plurality of thin-film magnetic head elements and a sliding surface for a magnetic tape;
a slot section running in a direction perpendicular to a magnetic tape transport direction, said slot section being arranged adjacent to said head section in the magnetic tape transport direction; and
an outrigger section provided with a sliding surface for the magnetic tape and arranged to separate from said head section by said slot section in the magnetic tape transport direction,
said sliding surface of said outrigger section including a sloped surface with a height that reduces as approaching said head section.

2. The multi-channel thin-film magnetic head as claimed in claim 1, wherein said multi-channel thin-film magnetic head further comprises a closure fixed on said plurality of thin-film magnetic head elements of said head section.

3. The multi-channel thin-film magnetic head as claimed in claim 1, wherein said sloped surface includes an inclined surface formed in an area of said sliding surface of said outrigger section near said head section.

4. The multi-channel thin-film magnetic head as claimed in claim 1, wherein said sloped surface includes an inclined surface formed over substantially whole area of said sliding surface of said outrigger section.

5. The multi-channel thin-film magnetic head as claimed in claim 1, wherein said sliding surface of said head section is arranged at a position nearer to said magnetic tape than a head-section side edge of said sliding surface of said outrigger section.

6. The multi-channel thin-film magnetic head as claimed in claim 1, wherein a head-section side edge of said sliding surface of said outrigger section is arranged at a position nearer to said magnetic tape than said sliding surface of said head section.

7. The multi-channel thin-film magnetic head as claimed in claim 6, wherein a height h′ is equal to or lower than a product of d×tan θ, where θ is an inclination angle of said sloped surface with respect to said sliding surface of said head section, h′ is a height of said sliding surface of said head section with respect to said head-section side edge and d is a width of said slot section in the magnetic tape transport direction.

8. The multi-channel thin-film magnetic head as claimed in claim 1, wherein a width d of said slot section in the magnetic tape transport direction is larger than 0.1 mm and smaller than 2.0 mm.

9. The multi-channel thin-film magnetic head as claimed in claim 1, wherein said plurality of thin-film magnetic head elements comprise a plurality of magnetoresistive effect read head elements and a plurality of inductive write head elements.

10. The multi-channel thin-film magnetic head as claimed in claim 9, wherein each of said plurality of magnetoresistive effect read head elements comprises a giant magnetoresistive effect read head element or a tunnel magnetoresistive effect read head element.

11. A multi-channel magnetic tape drive apparatus including a pair of multi-channel thin-film magnetic heads, a magnetic tape facing to said pair of multi-channel thin-film magnetic heads, and a drive system for relatively moving said magnetic tape and said pair of multi-channel thin-film magnetic heads,
each of said pair of multi-channel thin-film magnetic heads comprising:
a head section provided with a plurality of thin-film magnetic head elements and a sliding surface for a magnetic tape;
a slot section running in a direction perpendicular to a magnetic tape transport direction, said slot section being arranged adjacent to said head section in the magnetic tape transport direction; and
an outrigger section provided with a sliding surface for the magnetic tape and arranged to separate from said head section by said slot section in the magnetic tape transport direction,
said sliding surface of said outrigger section including a sloped surface with a height that reduces as approaching said head section.

12. The multi-channel magnetic tape drive apparatus as claimed in claim 11, wherein each of said pair of multi-channel thin-film magnetic heads further comprises a closure fixed on said plurality of thin-film magnetic head elements of said head section.

13. The multi-channel magnetic tape drive apparatus as claimed in claim 11, wherein, in each of said pair of multi-channel thin-film magnetic heads, said sloped surface includes an inclined surface formed in an area of said sliding surface of said outrigger section near said head section.

14. The multi-channel magnetic tape drive apparatus as claimed in claim 11, wherein, in each of said pair of multi-channel thin-film magnetic heads, said sloped surface includes an inclined surface formed over substantially whole area of said sliding surface of said outrigger section.

15. The multi-channel magnetic tape drive apparatus as claimed in claim 11, wherein, in each of said pair of multi-channel thin-film magnetic heads, said sliding surface of said head section is arranged at a position nearer to said magnetic tape than a head-section side edge of said sliding surface of said outrigger section.

16. The multi-channel magnetic tape drive apparatus as claimed in claim 11, wherein, in each of said pair of multi-channel thin-film magnetic heads, a head-section side edge of said sliding surface of said outrigger section is arranged at a position nearer to said magnetic tape than said sliding surface of said head section.

17. The multi-channel magnetic tape drive apparatus as claimed in claim 16, wherein, in each of said pair of multi-channel thin-film magnetic heads, a height h′ is equal to or lower than a product of d×tan θ, where θ is an inclination angle of said sloped surface with respect to said sliding surface of said head section, h′ is a height of said sliding surface of said head section with respect to said head-section side edge and d is a width of said slot section in the magnetic tape transport direction.

18. The multi-channel magnetic tape drive apparatus as claimed in claim 11, wherein, in each of said pair of multi-channel thin-film magnetic heads, a width d of said slot section in the magnetic tape transport direction is larger than 0.1 mm and smaller than 2.0 mm.

19. The multi-channel magnetic tape drive apparatus as claimed in claim 11, wherein, in each of said pair of multi-channel thin-film magnetic heads, said plurality of thin-film magnetic head elements comprise a plurality of magnetoresistive effect read head elements and a plurality of inductive write head elements.

20. The multi-channel magnetic tape drive apparatus as claimed in claim 19, wherein, in each of said pair of multi-channel thin-film magnetic heads, each of said plurality of magnetoresistive effect read head elements comprises a giant magnetoresistive effect read head element or a tunnel magnetoresistive effect read head element.
